(19) United States
(12) Patent Application Publication
(10) Pub. No.: US 2008/0013081 A1
(43) Pub. Date: Jan. 17, 2008

(54) SET OF SENSORS DETERMINING ALIGNMENT ANGLES, ANGLE MEASUREMENT SYSTEM AND PROCESS OF VEHICLE WHEELS ALIGNMENT

(76) Inventor: Roberto Gehlen Oliveira, Sao Paulo (BR)

Correspondence Address: STITES & HARBISON PLLC, 1199 NORTH FAIRFAX STREET, SUITE 900, ALEXANDRIA, VA, 22314, US

(21) Appl. No.: 11/621,616

(22) Filed: Jan. 10, 2007

(30) Foreign Application Priority Data
Sep. 21, 2006 (BR) PI 0604089-6

(51) Int. Cl. G01C 1/00; G01B 11/26

(52) U.S. Cl. 356/139.09; 356/155

(57) ABSTRACT

The present invention refers to a set of sensors and systems for determining alignment angles between plans, more particularly angles of a vehicle wheels alignment that in a fast and secure way, is able to offer an operator an accurate diagnosis of wheels alignment. More particularly, the present invention refers to a emitter sensor and at least one remote receiver sensor that are installed in a plan parallel to the one vehicle wheels, where the emitter sensor comprises a case, provided with at least one window and a receiver sensor of reference, which includes internally at least one motor connected by an axis to a circular fly wheel that supports a light source.

### BACKGROUND OF THE INVENTION

1. Field of the Invention

The present invention refers to a set of sensors for determining alignment angles of movable objects in a rotative way such as industrial pulley, machines in general, and, particularly automotive vehicle wheels.

More particularly, the present invention refers to equipment that is able to obtain inclination angles of objects in relation to a plan perpendicular to the rotation axis of a reference object through measuring emission time and reception signal combined with angular positioning of a rolling light source.

Additionally, the present invention refers to an alignment system that comprises a set of sensors that determines in a fast and accurate way inclination angles of rotative objects particularly automotive vehicle wheels instantly establishing necessary corrections for proper object alignment.

2. Description of the Prior Art

In a general way, it is known and used a number of methods, equipments and techniques to determine alignment angles that are applied according to nature of objects to be aligned, for example: equipments, machines, vehicles, determining alignment angles and inclination between plans, ranging different areas with specific objectives of each of them, such as automotive, civil construction, industrial machinery, vessels, etc.

Equipments for determining inclination angles of rotative objectives, such as a vehicle wheel or components of industrial machinery, equipments and methods ranging from the simplest, old and manual to the most complex, modern and automated are particularly known and used.

A first model known by those skilled in the art is the system that determines inclination angles through the called electric resistive film. This type of measuring occurs with activation of an electrically conductive cursor that is rotated over an electric resistive film to generate a specific parameter of variation of resistivity between the referred cursor and the path, which is related with the angular distance of referred conductive cursor to determine the inclination angles of the objects.

However, this type of system reveals the problem that the components responsible for determining parameters and, consequently, the inclination angles, are liable to mechanical waste causing failures in measurements accuracy, once they end up interfering on the resistivity levels between the two components.

Another system known in the state of art is the system that uses magnetic-resistive elements similar to the previous system, but having as a difference the fact the referred resistive film is liable of variations of tension and electrical current with conductive cursor in order to obtain the angular distance traveled by referred cursor. However, in this case, the magnetic-resistive elements suffer influence in measurement results due to eventual magnetic fields nearby the system.

In order to reduce mechanical interferences during alignment angle measurements, more modern systems began to adopt optical mechanisms. Today, some types of correlated equipments and systems are known. One of them is the system that uses technique of optical triangulation that comprises a light beam application in a mirror and/or panel, allowing the determination of distance between points of referred light beam. Said measurements are then inserted in trigonometric formulas to obtain inclination angles.

Although not having external interferences and mechanical wastes, in practice this type of system reveals other problems, mainly regarding to results accuracy level. More specifically, optical triangulation system uses metric scales that in general suffer with graduation imperfections. Additionally, measurements are done by operators at eyesight; hence, reading errors are liable.

Also known in the state of art, are the measurement systems by optical distribution that reveal extremely complex structures and assemblies that end up making it difficult the process of obtaining information. Measurement occurs through emission of a triangle or conical propagation light beam in photosensitive elements which generate electrical current with intensity that varies according to light concentration that incises over such elements, allowing, then, to determine inclination angles between pre-determined plans.

However, those systems require use of additional components to correct, filter, and convert signals captured by photosensitive elements to, thus, dispose data properly treated in a data processor for, finally, obtain the desired angle. Moreover, it is observed that most of the equipments that work with optical distribution technique use as light emitters Light Emitting Diode-type semiconductive photoemitter elements which emit light in the infrared spectrum zone, making it necessary the use of filters in the photosensitive elements to avoid environment light interference. Thus, systems like that are extremely complex and require highly trained and skilled technicians to determine inclination angles in an accurate and security way.

More recent systems use a laser cannon as light source to avoid external light interferences. Also, some equipment eliminates physical contact with rotative objects to eliminate interferences in reading accuracy.

Specifically regarding to automotive vehicles wheel alignment, equipments, methods and systems that use sensors, cameras and light emitter disposed next to vehicle wheels to measure the distance between the emitter components and pre-determined points of wheels are known, such as revealed on patent documents U.S. Pat. No. 4,863,266, U.S. Pat. No. 4,899,218, EP 0581990, U.S. Pat. No. 5,532,816; and U.S. Pat. No. 5,731,870.

Although such equipments and systems solve some problems regarding to luminosity and mechanical interference, they present disadvantages once they require pre-determination of points over surface of tires so that it is possible to the cameras capture the image, and the lens from these cameras must constantly be cleaned, requiring constant maintenances. These equipments also present a strong inconvenient related to result reliability whereas measurements are individually done for each wheel of the vehicle without having an interrelationship in the simultaneous alignment between the four wheels of the vehicle.

In order to solve the above-mentioned inconvenience, more modern equipments have been developed with accuracy levels superior to previous ones, such as documents WO 95/29378, U.S. Pat. No. 6,327,85 and Brazilian patent application PI 9901148-4, being the latter created by the inventor of the present invention. Basically, such equipments use as light emitter a fixed laser cannon that emits a light beam over a rotative reflexive surface such as a mirror that directs the referred light beam directed to receivers sensors placed distant from emitter, for example, the emitter placed in one of the frontal wheels of the vehicle and the receiver sensor on the back wheel.

Taking into account that the mirrors are rotative, reflected light beams are periodical so that receiver sensors periodically capture signal and, then, it is possible to measure time of emission and reception. Consequently, alignment angles between vehicle wheels are determined.

However, it was verified that the equipment and system of alignment, particularly wheels vehicles could be improved regarding to accuracy and simplification in the process of achievement of data for determining wheels inclination angles. More specifically, it was verified that, although rotative reflexive surfaces are on single plan, it was not possible to eliminate natural deviates of reflection besides the necessity of requiring constant cleaning and on the continuous suffering with environment light, mainly solar light. Additionally, such rotative reflexive surfaces acted in a range radius limited to about 180°.

Therefore, it is clear that the equipments and systems known in the state of art keep on presenting some inconvenient and limitations mainly regarding to efficiency, accuracy and security levels in the process of determining rotative alignment angles, such as automotive vehicle wheels.

### SUMMARY OF THE INVENTION

The present invention refers to a set of sensors and a system for determining alignment angles of rotative objects in general. It is important to clarify that in a non limitative way, the present invention will be described making references more particularly to automotive vehicles, but any person skilled in the art will know that the present invention is also to be applied in mechanisms and machines that use wheels, pulleys, and gears which require a suitable alignment to rotate without interfere as a whole, being it a vehicle or a machine.

Thus, the present invention seeks to provide a set of sensors used for determining alignment angles between plans and, preferably, for measuring wheels alignment angles of a vehicle, in a practical, reliable and secure way.

More particularly, the present invention seeks to provide a set of sensors that solves the inconvenient revealed by the state of the art eliminating possible components that influence and interfere in the obtainment of data. The set of sensors also processes the data to considerably increase accuracy levels of result as well as reducing time for determining and correcting of the inclination angles of wheels.

Another objective of the present invention is a set of sensors that provides a radius ranging about 360° and, therefore, allowing through a single equipment to perform several readings in different measurement points, simultaneously. Additionally, data are collected in several sweepings in a consecutive way making the average result to present higher accuracy when compared to state of the art in which data are collected and analyzed in a single sweeping cycle.

It is also another objective of the present invention to provide a set of sensors that uses a direct technique of light emission to eliminate components that eventually may interfere or provide deviations or errors in the light beam tracking.

Additionally, it is an objective of the present invention to provide a process of alignment, more particularly of automotive vehicles wheels, that comprises inclination angle analysis, obtainment of respective correction angles using the angles determining set of sensors according to the present invention, and finally, the alignment of the objects.

The, set of sensors for determining vehicles wheels angle alignment according to present invention basically comprises an emitter element and at least one remote receiver element, the referred emitter element emits a direct light beam in at least one of the receivers, collecting data related to the angular movement and the emission and reception time of the beam. In this way, through a central of data processing it can be determine the wheel or wheels inclination angles.

Additionally, it is an objective of the present invention to provide a system that comprises the set of sensors hereinabove defined for determining automotive vehicles wheels angle alignment. More specifically, the system of the present invention provides flexibility of utilization in different types of applications for measuring angle alignment among plans in general.

These and other objectives improvements and technical advantages of the set of sensors and wheels alignment system, according to the present invention, will appear to those skilled in the art from the following detailed description which refers to the attached schematic figures below.

### BRIEF DESCRIPTION OF THE DRAWINGS

FIG. 1 illustrates a lateral view of the set of sensors for determining inclination angle between plans, according to the present invention;

FIG. 2 illustrates an upper cut view of the set of sensors for determining inclination angle between plans, according to the present invention;

FIG. 3 illustrates an upper view of a first performance of application using the set of sensors for determining inclination angle illustrated on FIG. 2;

FIG. 4 is an upper view similar to the one illustrated on FIG. 3, but with one of the wheels not aligned;

FIG. 5 illustrates an upper view of a second embodiment of the set of sensors for determining inclination angle between plans, according to the present invention;

FIG. 6 illustrates an upper view of an application embodiment using the set of sensors for determining inclination angle illustrated on FIG. 5;

FIG. 7 illustrates a schematic diagram of an embodiment of the processing center according to the present invention;

FIG. 8 illustrates a schematic diagram of a second embodiment of the central processing center according to the present invention;

FIG. 9 illustrates an upper view of a third embodiment of the set of sensors for determining inclination angle between plans, according to the present invention, using indirect measurement technique; and

FIG. 10 is a similar view to the one illustrated on FIG. 7, but with the reflection plan not aligned.

### DETAILED DESCRIPTION OF THE INVENTION

Initially, in order to make it easy to understand the constructive elements of the set of sensors for determining inclination angle of vehicle wheels alignment, according to the present invention as well as their embodiments, numerical references will not be integrally repeated in all figures, since it would make it difficult to understand details illustrated on them.

According to the above-mentioned figures, the set of sensors for determining inclination angle of vehicle wheels alignment basically comprises an emitter sensor (1) and at least on remote receiver sensor (2).

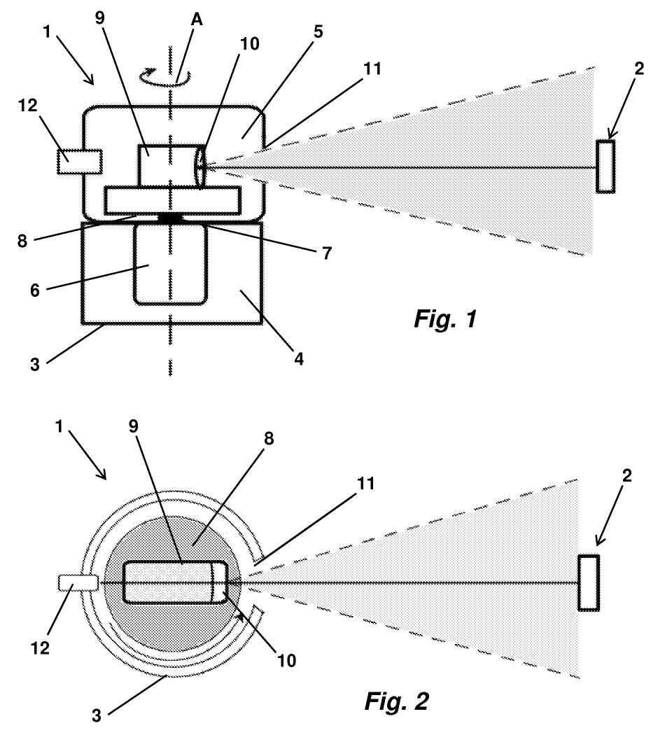

In FIG. 1 emitter sensor (1) generates a signal directed to the remote receiver sensor (2). Emitter sensor (1) comprises a case (3) that creates two shelters, one inferior shelter (4) and one superior shelter (5) wherein referred inferior shelter (4) keeps a motor (6) that is able to rotate, in a constant way, an axis (7) connected to the center of a circular fly wheel (8) placed inside the superior shelter (5) of the case (3), being the said circular fly wheel (8) relatively heavy to promote a uniform and efficacious rotation.

The referred motor (6) may be of any kind, since it is able to rotate the circular fly wheel (8) in a constant speed. For example, motor (6) may be an electric or pneumatic motor.

Also referring to FIG. 1, circular fly wheel (8) supports a light source (9) that emits in a constant way a light beam, that may be in the visible spectrum or not, according to the source type used, that can be an incandescent lamp, halogenous, fluorescent, a Light Emitting Diode, a laser cannon or any light source with exact lined or conical propagation. In a particularly advantageous way, it is used as light source a semiconductive photoemitter element, such as a Light Emitting Diode and, preferably used a laser cannon, which can reduce interference levels of environment light, and also, presents a superior range in relation to other types of light source.

Light source (9) also comprises a lens (10) placed on the light beam output so that to convert it in one line with divergent propagation. Mainly, in cases where cannons are used, those sources generate cylindrical light beams being reflected as simple point. Thus, through the said lens it is possible to transform cylindrical light beam in a conical light beam, so that to transform simple reflected point into a line. Such aspect can increase the range of light beams generated by emitter sensor making non-alignment more tolerable.

Superior shelter (5) has at least one window (11) that permits light beam passage towards the remote receiver sensor (2), and also comprises a reference receiver sensor (12) whose angled position is known and pre-determined.

As illustrated by the arrow (A), the light source (9) fixed over the circular fly wheel (8) is rotated by the axis (7) of the motor (6) in a constant speed so that at each turn of the light source (9), a signal is collected by the reference receiver sensor (12) and another by the remote receiver sensor (2). At each turn the set of sensors of the present invention obtain time data and angular position of the light source (9) at the moment in which signals are captured by receiver sensors (2, 12). Also, in a particularly advantageous embodiment, the emitter sensor (1) is provided with a second motor placed at 180° in relation to the first so that to increase mechanical rigidity of the set formed by circular fly wheel (8) and light source (9).

Receiver sensors are basically photosensitive elements able to convert luminous incident signal into electrical signal. More particularly, they can be photodiode, phototransistors, Light Dependent Resistor elements, integrated receiver circuits, elements like Charge-Coupled Devices, or Charge Injection Devices.

FIG. 2 illustrates an embodiment of the invention in which the superior shelter (5) of the emitter sensor (1) comprises a single window (11) for emission of light beam towards the remote receiver sensor (2). In the attached figures, the reference receiver sensor (12) is placed in an aligned way at 180° in relation to the line center of the receiver sensor, but it is clear to any person skilled in the art that the reference receiver sensor (12) may be placed anywhere around the superior shelter (5), since such angular position related to the center line of the emitter is known.

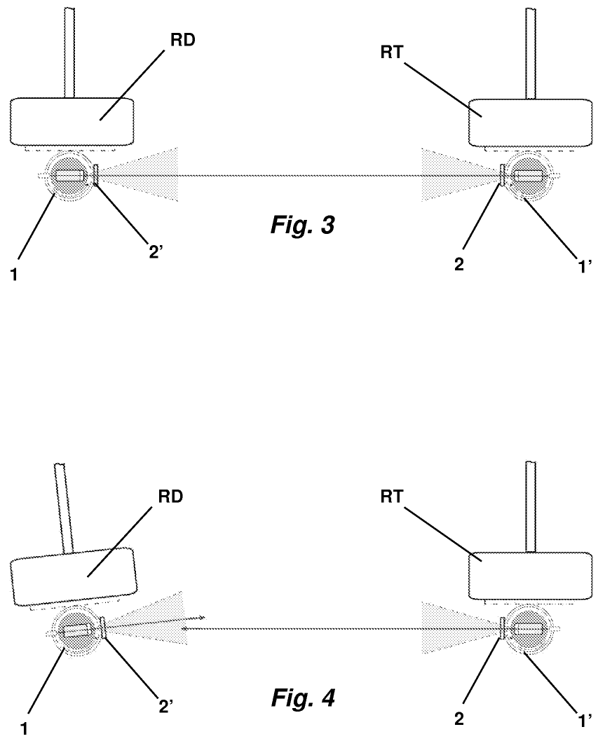

FIGS. 3 and 4 illustrate the set of sensors of the present invention in an alignment application of an automotive vehicle wheels. In order to make the analysis and understanding of the present invention easy, these figures illustrate just the frontal (RD) and rear wheels (RT) in one side of the vehicle.

The remote receiver sensor (2), placed on the rear wheel (RT) captures the light beam signal emitted by the emitter sensor (1) placed on the frontal wheel and informs a processing center (P) not illustrated. At the same time, the remote receiver sensor (2′), placed on the frontal wheel (RD), captures a signal emitted by emitter sensor (1′) of the rear wheel (RT) and leads it to the processing center (P). In this processing center time and angle position of the light source (9) are properly filtered, analyzed and processed to provide a diagnosis of the vehicle's wheels alignment.

As illustrated in FIG. 3, the determined result is that wheels are properly aligned without presenting angle deviations. This is possible because the reference receiver sensors (12) are placed at 180° from the center line of the emitter sensor (1, 1′). By performing “n” turns of the light source (9), processing center (P) detects that it does not exists difference in time and light beam's angular position, and, therefore, said wheels (RD, RT) are aligned.

In FIG. 4 it is illustrated a situation in which the front wheel (RD) is slightly not aligned. Thus, by putting the set of sensors according to the present invention to run, it is verified that the light source (9) needs rotating some degrees for more or less and it takes more or less time depending on the alignment level, so that the light beam reaches remote receiver sensor placed on the other wheel. Therefore, processing center (P) detects difference in time and angular position generating as a result the correction angle needed for said wheel.

Although figures illustrate just two wheels from the same side of a vehicle, it is possible to dispose more sets of sensors on the vehicle wheels so that it is possible to determine and align the four wheels in a simultaneous way. For this, by using emitter sensors as hereinabove described, it would be enough to have eight sets (two for each wheel) to determine alignment angles between frontal wheels, between rear wheels, and also, between the wheels on each side of the vehicle.

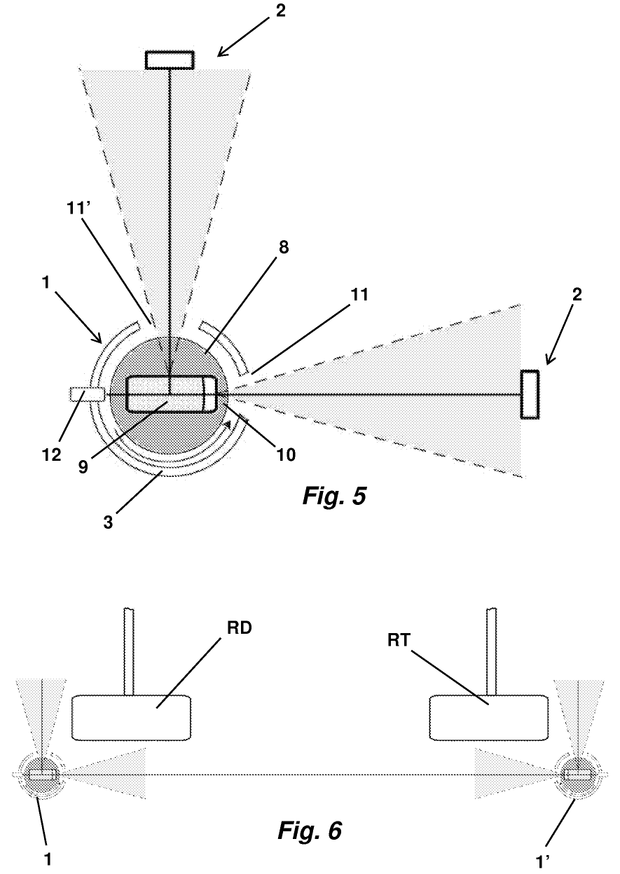

FIGS. 5 and 6 illustrate an alternative embodiment of the set of sensors from the present invention whose objective is to reduce implementation costs, once it enables elimination/reduction of some sets placed and distributed on the vehicle's wheels.

At the embodiment illustrated on FIGS. 5 and 6, the superior shelter (5) of the emitter sensor (1) comprises two windows (11, 11′) for emission of light beam generated by the only light source (9). Data collect occurs in the same way as previously described, but instead of duplicating the number of sets (emitter plus remote receiver), remote receiver sensors are duplicated. Thus, through one single light source (9) it is possible to determine alignment angles of two different plans such as illustrated on FIG. 6.

It becomes clear, thus, that the set of sensors object of the present invention allows determining different inclination angles between plans with a single emitter sensor providing additional windows on the superior shelter (5) of the case (3), for example, two, three, four, etc. The range radius of the emitter sensor may be up to 360°, according to the necessity and type of desired application and measurement.

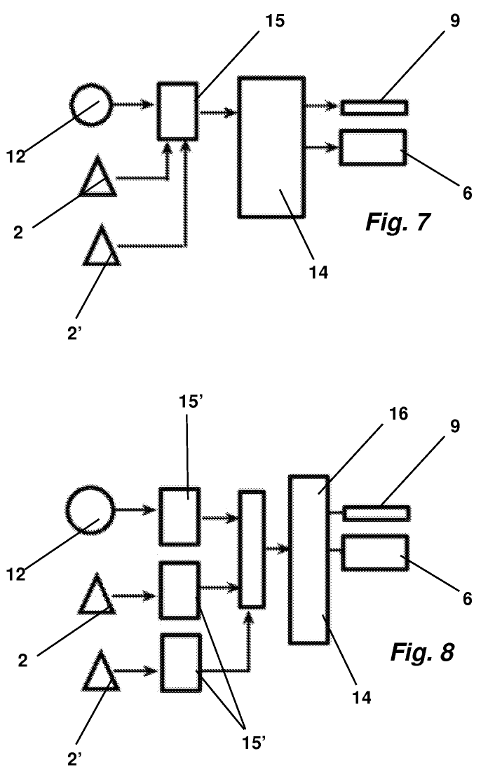

Regarding FIGS. 7 and 8, the processing center comprises a controller (14) (micro-controller or microprocessor) and at least one incremented counter in constant intervals (15) called time base, which is normally stabilized by a quartz crystal. Said controller (14) commands all components of the set of sensors object of the present invention, from motor (6) to light source feed (9) of each emitter sensor (1) used in the application. As it is possible to observe in FIG. 8, for each receiver sensor, being it reference or remote, there is an individual time base (15′) that afterwards groups all data in a single central base (16) so that to send them to the controller (14), wherein they are treated and processed to provide diagnosis about conditions of analyzed wheels.

Thus, at each incidence of light on remote receivers (2, 12), it is generated an electrical pulse that consequently generates a data that is read by time base in a substantially instantaneous way and next processed by controller (14), in which it is performed the equation herein below to determine difference in angle on the wheel

$$\sum n \frac{[ \frac{( A - R ) \times 360 °}{( R - {R}^{′} )} ]}{n}$$

in which:

R is the read number at the moment in which light incises on the reference receiver sensor (12);

R′ is the read number at the same moment as R, but collected at the previous turn;

A is the read number at the moment in which light incises on the remote receiver sensor (2); and

n is the number of turns realized by the light source.

Through hereinabove data, the controller (14) obtains a vehicle wheel inclination angle value. It is observed that the formula hereinabove produces a weighted average of data collected in each turn of the light source, so, the higher the number “n”, the more accurate will be the obtained result.

Additionally, connected to the processing central, there is an interface of visualization so that the operator may be aware of the results. This interface of visualization may be of any type, such as a monitor, a printer, or an indicative light panel, that is, any device that allows visualization of results generated by the processing center.

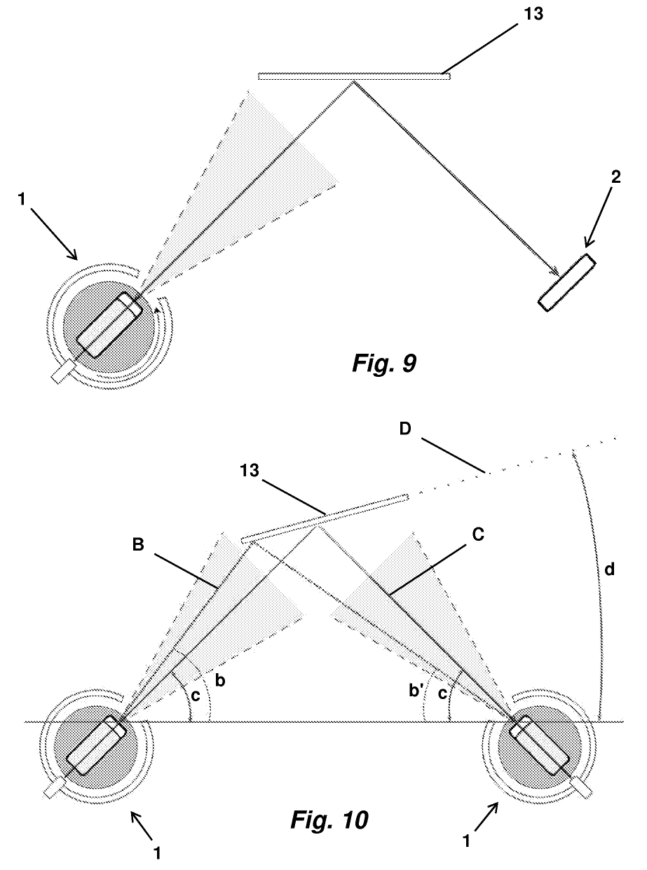

FIGS. 9 and 10 illustrate another embodiment of the set of sensors according to the present invention. In this embodiment it is used an indirect measuring technique, once it uses reflexive surfaces to determine inclination angles between determined plans. Therefore, it is clear that measuring components, emitter sensor (1) and remote receiver sensor (2) are identical to the ones used previously.

This type of embodiment is also applied in automotive vehicle wheels where over frontal surface of the wheel and parallel to it, it is placed a reflexive surface so that to simulate wheel alignment plan. Also, such performance determines inclination angles of each wheel individually for even measuring wheel angles in relation to an axis.

As illustrated in FIG. 9, emitter sensor (1) emits light beam that is reflected over reflexive surface (13), leading it to remote receiver sensor (2). Similarly to previous performances, data of time and angular positioning of light source are measured and sent to the processing center (P), in which they are calculated and processed in order to obtain the respective inclination angles of reflexive surface, that is, the angle of the wheel.

FIG. 10 illustrates a situation in which the wheel of a vehicle is not aligned and, then, a reflexive surface (13) is placed in a non-aligned way. In this figure, solid lines (C) represent ideal light beams (wheel properly aligned) and that form equal angles (c), dotted lines (B) represent light beams with irregularities on the wheel and present different angles (b, b′), line (D) represents the not aligned reflexive surface plan with a non aligned angle (d) that is the angle of interest and for proper alignment of wheel/reflexive surface alignment.

Thus, for determining the correction angle (d) the set of sensors identify respective non-aligned angle (b, b′), as processing center (P) knows the aligned angles (c), by making trigonometric calculus it is possible to obtain the angle of interest (d). That is, the processing center applies the following formula to obtain correction angle, assuming that the center of emitter sensors is at 45° from the aligned measuring plan:

$$d = \frac{( Set angle 1 - Set angle 2 )}{2}$$

$$in which \text{:}$$

$$\underline{Set angle 1 = b - 45 \underline{°}}$$

$$and$$

$$\underline{Set angle 2 = {b}^{′} - 45 \underline{°}}$$

Thus, by determining angle (d), the operator may correct the vehicle's wheel alignment in a secure and efficacious way.

The process of the present invention is a rotative object alignment process, more particularly of vehicle wheels that comprises basically the steps of:

i) analysis of inclination angles of vehicles wheel;

ii) determination of correction angles of vehicles wheels;

iii) alignment of vehicle wheels,

where steps i) and ii) are done by the set of sensors for determining alignment angles according to the present invention previously defined and step iii) is done in a manual way by an operator or automated through a machine like an industrial robot, a mechanical arm, or a machine that can perform task of correcting referred not aligned angles.

Therefore it is verified that with the set of sensors, according to the present invention it becomes possible to eliminate many inconvenient identified in the state of the art, mainly regarding to accuracy and fast level in reading and providing results.

1. A set of sensors for determining alignment angles comprising an emitter sensor and at least a remote receiver sensor, connected to a processing center, said emitter sensor comprised by a case where it is disposed at least one motor whose axis is fixed in the center of a circular fly wheel that supports a light source, said case provided with at least one opening and a receiver sensor of reference.

2. The set of sensors according to claim 1, wherein said receiver sensors are photosensitive elements that are able to convert luminous incident signal into an electrical signal.

3. The set of sensors according to claim 2, wherein said receiver sensors are selected from the group consisting of: photodiode, phototransistors, Light Dependent Resistor elements, integrated receiver circuits, elements like Charge-Coupled Device, and Charge Injection Devices.

4. The set of sensors according to claim 1, wherein said case of said emitter sensor comprises an inferior shelter to keep said motor and a superior shelter where said circular fly wheel and the light source are placed.

5. The set of sensors according to claim 1, wherein said motor is an electrical or a pneumatic motor.

6. The set of sensors according to claim 1, further comprising two motors placed at 180° one related to the other.

7. The set of sensors according to claim 1, wherein said light source is a semi conductive photo emitter element that generates an exact light beam in line or conical shape.

8. The set of sensors according to claim 7, wherein said light source is selected from the group consisting of: incandescent lamp, halogenous, fluorescent, a Light Emitting Diode, and a laser cannon.

9. The set of sensors according to claim 8, wherein said light source is a laser cannon.

10. The set of sensors, according to claim 1, wherein said light source includes a lens.

11. The set of sensors according to claim 1, wherein the amount of windows distributed around said case is between 1 and 3.

12. The set of sensors according to claim 1, wherein said processing center comprises a microcontroller or a microprocessor and at least an incremented counter in constant intervals.

13. The set of sensors according to claim 12, wherein said microcontroller or said microprocessor controls said motor, said light source, said receiver sensor of reference and said remote receiver sensor.

14. The set of sensors according to claim 12, wherein said incremented counter in constant intervals is a time base counter stabilized by a quartz crystal.

15. The set of sensors according to claim 1, wherein said processing center comprises an individual time base for each receiver sensor, which is connected to a centralizer single time base.

16. The set of sensors according to claim 1, wherein said processing center is connected to an interface of visualization that enables the visualization of the results through an operator selected from the group consisting of: a monitor, a printer, and a light panel.

17. An angle measurement system for vehicle wheels alignment, comprising in a plan parallel to the frontal face of each wheel, at least one set of sensors as defined in claim 1.

18. The angle measurement system according to claim 17, further comprising a reflexive surface attached to a frontal face of each vehicle wheel.

19. A process for vehicle wheels alignment comprising the steps of:
i) analysis of inclination angles of vehicles wheel;
ii) determination of correction angles of vehicles wheels, and
iii) alignment of vehicle wheels,
wherein
steps i) and ii) are done by the set of sensors for determining alignment angles according to claim 1, and step iii) is done in a manual way by an operator or automated through a machine.

20. The process according to claim 19, wherein said machine is selected from the group consisting of: an industrial robot, a mechanical arm, and a machine that can perform task of correcting not aligned angles of said wheels.
